(19) United States
(12) Patent Application Publication
(10) Pub. No.: US 2007/0208585 A1
(43) Pub. Date: Sep. 6, 2007

(54) Systems and methods for providing time-in-transit information to a user

(76) Inventors: Douglas Bernhard, Roswell, GA (US); Frank Loch, Shelbyville, KY (US); Sumeet Shroff, Chamblee, GA (US); Anna Thomas, Cockeysville, MD (US); Paul Vassallo, Atlanta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/368,944

(22) Filed: Mar. 6, 2006

(51) Int. Cl. G06Q 10/00; G06Q 30/00

(52) U.S. Cl. 705/1

(57) ABSTRACT

Systems and methods for allowing a user to input a zip code and select between receiving a time-in-transmit map for shipments inbound to the zip code or a time-in-transmit map for shipments outbound from the zip code, and displaying the requested time-in-transmit map to the user. Alternatively, a user may request to view both an inbound and outbound time-in-transmit map for a particular zip code, or may toggle between viewing an inbound and outbound time-in-transmit map for the particular zip code.

### BACKGROUND OF THE INVENTION

In the package delivery industry, common carriers, such as United Parcel Service (UPS), deliver packages between customers. A customer may be either a consignor or a consignee. The “consignor” is the customer sending a package or shipment by a common carrier. The “consignee” is the recipient of that package or shipment.

Generally, consignors often have a need to know how long it will take for a package shipped by them to reach one or more destination locations. Likewise, consignees often have a need to know how long it will take for an inbound package to reach them from one or more origin locations. Current systems can make it difficult for consignors and consignees to obtain this information.

Accordingly, there is a need in the art for improved systems and methods for providing time-in-transmit information to customers.

### BRIEF SUMMARY OF THE INVENTION

A computer system according to one embodiment of the present invention is adapted for: (1) receiving a location identifier from a user, the location identifier corresponding to a first location; (2) receiving, from the user, a “display outbound information” request that information be provided regarding the time that it would take to ship a parcel from the first location to a second location; (3) receiving, from the user, a “display inbound information” request that information be provided regarding the time that it would take to ship a parcel from the second location to a first location; (4) at least partially in response to receiving the “display outbound information” request, providing information to the user regarding the time that it would take to ship a parcel from the first location to the second location; and (5) at least partially in response to receiving the “display inbound information” request, providing information to the user regarding the time that it would take to ship a parcel from the second location to the first location.

A computer system according to another embodiment of the present invention is adapted for: (1) receiving a location identifier from a user, the location identifier corresponding to a particular location; (2) receiving, from the user, a “display inbound time-in-transmit map” request that an inbound time-in-transmit map be displayed, the inbound time-in-transmit map indicating the time that it would take to ship a parcel from each of a plurality of locations to the particular location; (3) receiving, from the user, a “display outbound time-in-transmit map” request that an outbound time-in-transmit map be displayed, the outbound time-in-transmit map indicating the time that it would take to ship a parcel from the particular location to each of the plurality of locations; (4) at least partially in response to receiving the “display inbound time-in-transmit map” request, displaying the inbound time-in-transmit map to the user; and (5) at least partially in response to receiving the “display outbound time-in-transmit map” request, displaying the outbound time-in-transmit map to the user.

A computer system according to yet another embodiment of the present invention is adapted for: (1) receiving a location identifier from a user, the location identifier corresponding to a particular location; and (2) allowing the user to issue a “display inbound time-in-transmit map” request that an inbound time-in-transmit map be displayed, the inbound time-in-transmit map indicating the time that it would take to ship a parcel from each of a plurality of locations to the particular location.

A computer-readable storage medium, according to one embodiment of the present invention, stores computer-executable instructions for: (1) receiving a location identifier from a user, the location identifier corresponding to a first location; (2) receiving, from the user, a “display outbound information” request that information be provided regarding the time that it would take to ship a parcel from the first location to a second location; (3) receiving, from the user, a “display outbound information” request that information be provided regarding the time that it would take to ship a parcel from the second location to the first location; (4) at least partially in response to receiving the “display outbound information” request, providing information to the user regarding the time that it would take to ship a parcel from the first location to the second location; and (5) at least partially in response to receiving the “display inbound information” request, providing information to the user regarding the time that it would take to ship a parcel from the second location to the first location.

A computer-readable storage medium, according to another embodiment of the present invention, stores computer-executable instructions for: (1) receiving a location identifier from a user, the location identifier corresponding to a particular location; (2) receiving, from the user, a “display inbound time-in-transmit map” request that an inbound time-in-transmit map be displayed, the inbound time-in-transmit map indicating the time that it would take to ship a parcel from each of a plurality of locations to the particular location; (3) receiving, from the user, a “display outbound time-in-transmit map” request that an outbound time-in-transmit map be displayed, the outbound time-in-transmit map indicating the time that it would take to ship a parcel from the particular location to each of the plurality of locations; (4) at least partially in response to receiving the “display inbound time-in-transmit map” request, displaying the inbound time-in-transmit map to the user; and (5) at least partially in response to receiving the “display outbound time-in-transmit map” request, displaying the outbound time-in-transmit map to the user.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of time-in-transmit system according to one embodiment of the present invention.

FIG. 2 is a diagram of a time-in-transmit server according to one embodiment of the present invention.

FIG. 3 is a flow diagram that illustrates the steps of displaying time-in-transmit information to a user according to one embodiment of the present invention.

FIG. 4 depicts a map indicating the transmit times of a parcel between several locations.

FIG. 5 depicts a time-in-transmit map request screen according to one embodiment of the present invention.

FIG. 6 depicts an Inbound View time-in-transmit map screen according to one embodiment of the present invention.

FIG. 7 depicts an Outbound View time-in-transmit map screen according to one embodiment of the present invention.

FIG. 8 depicts a time-in-transmit map request screen according to one embodiment of the present invention which allows a user to enter more than one ZIP code.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

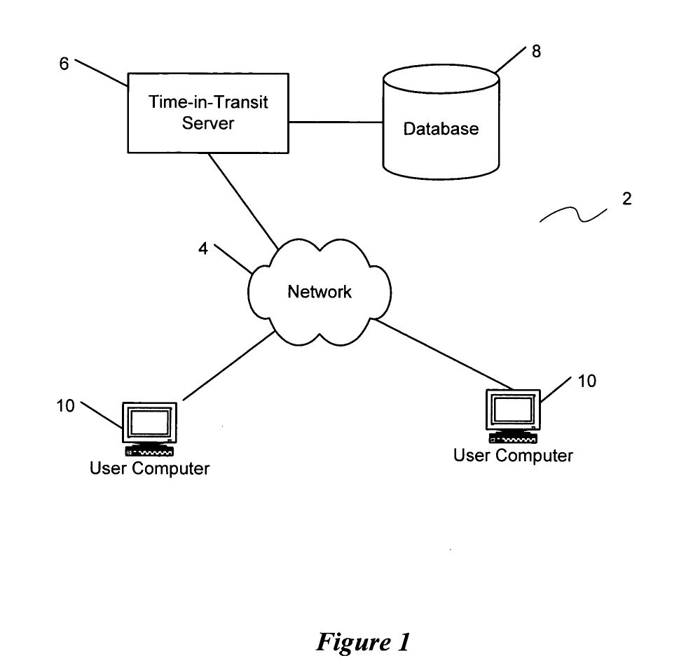

A time-in-transmit system 2 according to one embodiment of the invention is shown in FIG. 1. As may be understood from this figure, in this embodiment, the system 2 includes at least one user computer 10 that is connected (e.g., via a network 4 such as a LAN or a global communications network, such as the Internet) to communicate with a time-in-transmit server 6. In one embodiment of the invention, the time-in-transmit server 6 is configured for retrieving data from, and for saving data to, a database 8 that may be stored on (or, alternatively, stored remotely from) the time-in-transmit server 6.

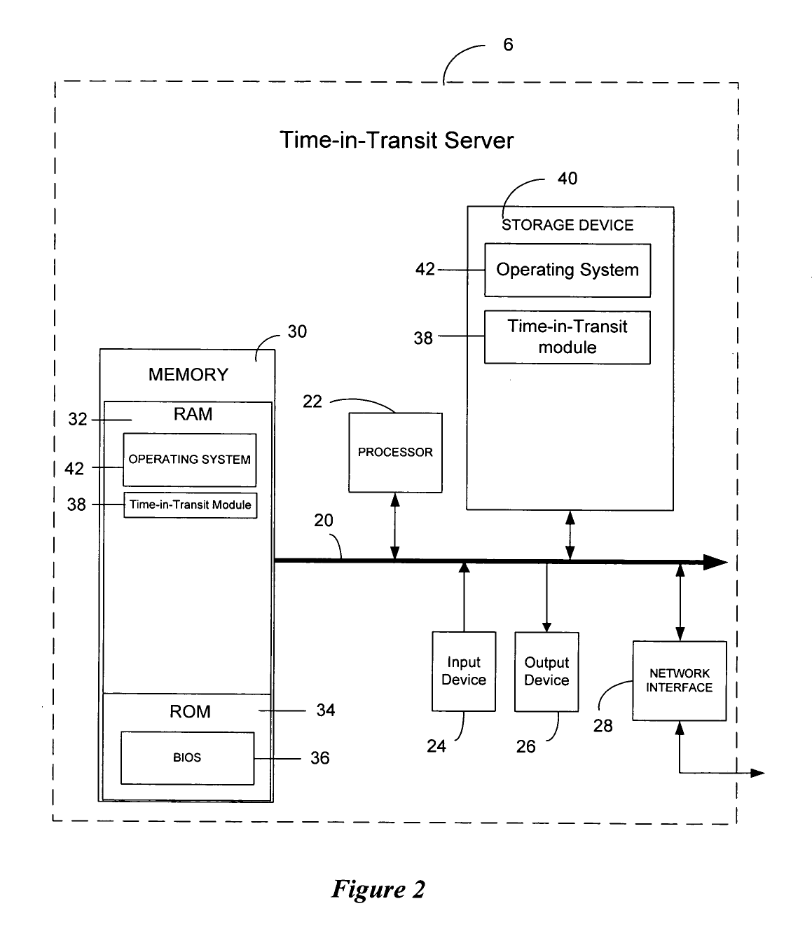

FIG. 2 shows a schematic diagram of a time-in-transmit server 6 according to one embodiment of the invention. As may be understood from this figure, in this embodiment, the time-in-transmit server 6 includes a processor 22 that communicates with other elements within the time-in-transmit server 6 via a system interface or bus 20. Also included in the time-in-transmit server 6 is an input device 24 for receiving data, and an output device 26 for displaying data. The input device 24 may be, for example, a keyboard or pointing device that is used in combination with an output device. The output device 26 may be, for example, a monitor. The time-in-transmit server 6 further includes memory 30, which preferably includes both read only memory (ROM) 34 and random access memory (RAM) 32. The time-in-transmit server's 6 ROM 34 is used to store a basic input/output system (BIOS) 36, containing the basic routines that help to transfer information between elements within the time-in-transmit server 6.

In addition, the time-in-transmit server 6 includes at least one storage device 40, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 40 is connected to the system bus 20 by an appropriate interface. The storage devices 40 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices 40 and within RAM 32. Such program modules may include an operating system (OS) 42 and a time-in-transmit module 38. The time-in-transmit module 38 controls certain aspects of the operation of the time-in-transmit server 6, with the assistance of the processor 22 and the operating system 42.

Also located within the time-in-transmit server 6 is a network interface 28, for interfacing and communicating with other elements of a computer network. It will be appreciated by one of ordinary skill in the art that one or more of the time-in-transmit server 6 components may be located geographically remotely from other time-in-transmit server 6 components. Furthermore, one or more of the components may be combined, and additional components performing functions described herein may be included in the time-in-transmit server 6.

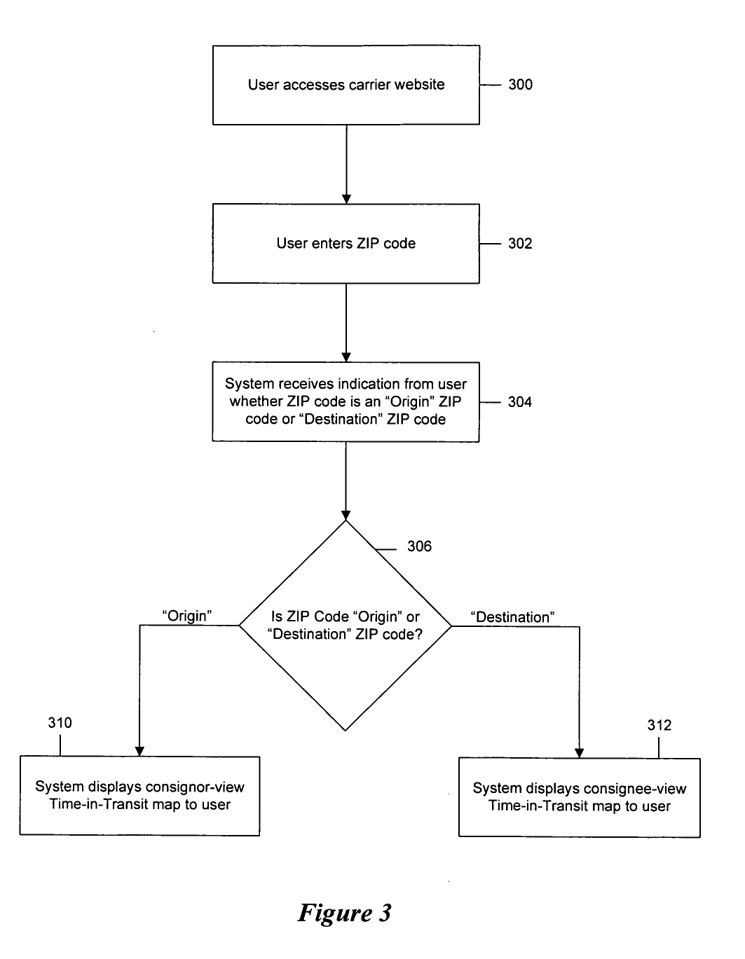

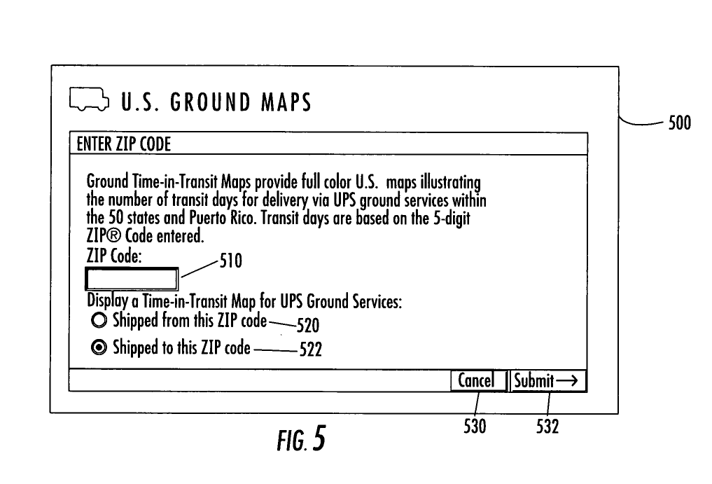

FIG. 3 shows a flow chart illustrating the steps of providing time-in-transmit information to a user in response to a user's request, in accordance with one aspect of the present invention. At step 300, a user may access a carrier's website (e.g., by using a remote computer to log onto the carrier's website via the Internet or other suitable network). The user may be a consignee, consignor, or other individual. At step 302, the user enters a location identifier, which in at least one embodiment is a zip code. Other suitable location identifiers may be: (1) a street address; (2) a street address in combination with a city and state indication; (3) a city and state indication; (4) a state indication; (5) an area code; or (6) any other suitable location identifier known in the art. In an alternative embodiment, a location identifier may identify an international location. In such an embodiment, a user may indicate the country, as well as a postal code, city, or other location identifier for that country. In a particular embodiment, at step 302, the user may enter a zip code in a location identifier field 510, as shown in FIG. 5.

At step 304, the user may indicate whether the zip code entered at step 302 represents an “origin” zip code, or a “destination” zip code. In a particular embodiment, the user may indicate that the zip code is an “origin” zip code by selecting a “Shipped from this ZIP code” radio button 520 on the carrier's website, as shown in FIG. 5. Alternatively, the user may indicate that the zip code is a “destination” zip code by selecting a “Shipped to this ZIP code” radio button 522, as shown in FIG. 5. As will be appreciated by one of ordinary skill in the art, a radio button is typically used to allow a user to select one—and only one—option from a list of alternatives. In an alternative embodiment (not shown), a user may be provided with check boxes, which would allow a user to select multiple options (e.g., “Shipped from this ZIP code” 520, and “Shipped to this ZIP code” 522), in order to receive a display of multiple time-in-transmit maps in one transaction.

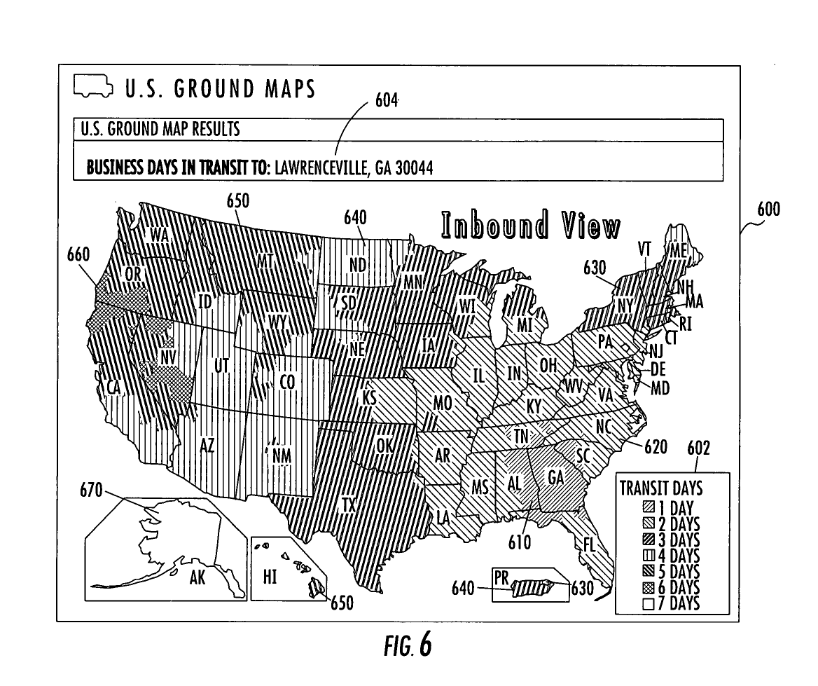

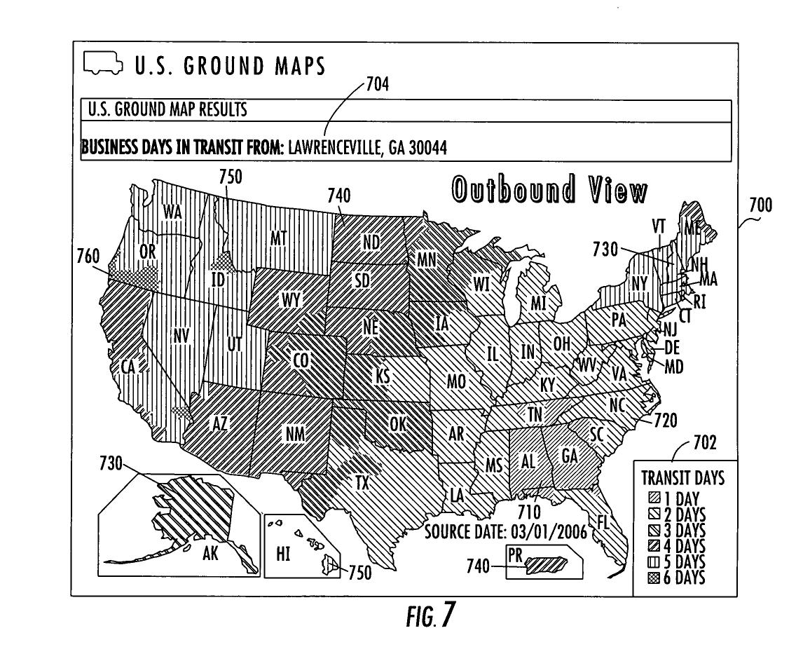

At step 306, the system determines whether the user has designated the zip code entered at step 302 as an “origin” zip code or a “destination” zip code. If the zip code indicates an “origin” location, the system displays, at step 310, a consignor-view (or Outbound View) time-in-transmit map to the user. An example of an Outbound View time-in-transmit map is shown in FIG. 7. If the zip code indicates a “destination” location, the system displays, at step 312, a consignee-view (or Inbound View) time-in-transmit map to the user. An example of an Inbound View time-in-transmit map is shown in FIG. 6.

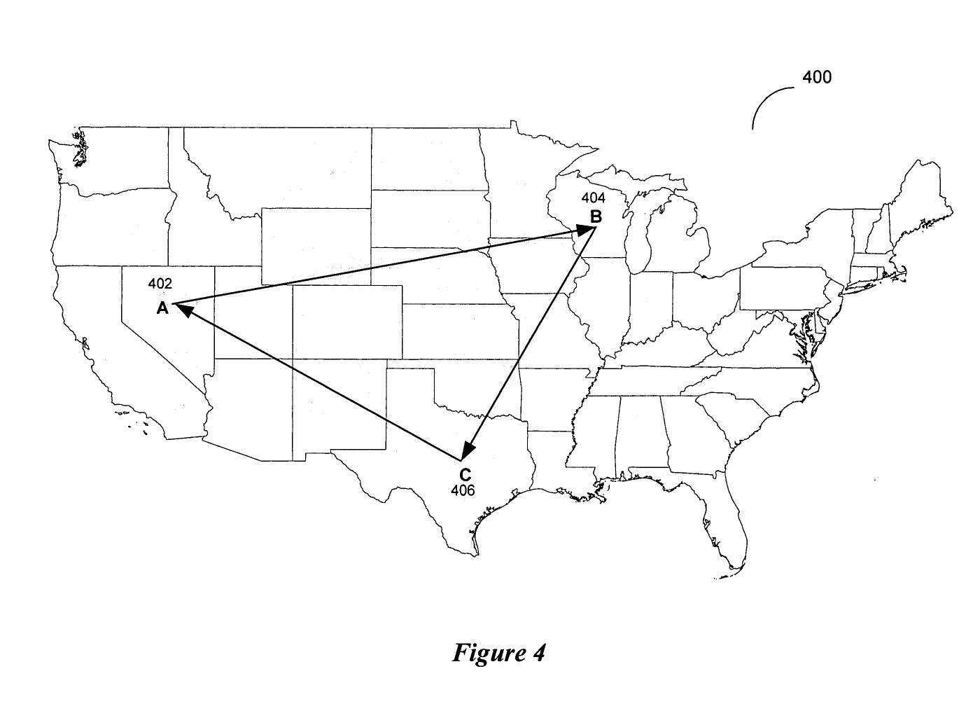

A particular user may desire to have access to both Outbound View and Inbound View time-in-transmit maps because, in many cases, the time-in-transmit of a parcel (e.g., a letter or package) sent from a first location to a second location may not equal the time-in-transmit of a parcel sent from the second location to the first location. Such a situation is represented, by way of example, in FIG. 4, which generally shows a map 400. FIG. 4 illustrates that a parcel traveling from point A 402 to point B 404, may take a direct route. However, a parcel traveling from point B 404 to point A 402, may take a route that travels through point C 406. In such a situation, the travel time from point A 402 to point B 404 may be less than the travel time between point B 404 and point A 402. As will be appreciated by one skilled in the art, the asymmetric relationship of travel times between two cities may be due to the particular organization of shipping lanes between those cities in the case of ground or air transportation. Additionally, and particularly in the case of air travel, the travel time between two locations may vary in each direction due to wind patterns and currents that may favor travel in one direction.

As an aside, we note that the use of the word “time” in “time-in-transmit” as used herein is intended, in most cases, to indicate a general estimated amount of time that a parcel will be in transmit to or from a particular indication. For example, in various embodiments, a one day “time-in-transmit” is intended to indicate that, if a parcel is shipped on a particular day, it will (under normal circumstances) arrive at its destination on the next of the shippers' regular shipping days. It should be understood that in most cases, as used herein, the terms “time” and “time-in-transmit” are not meant to signify an exact time in transmit.

As discussed above, FIG. 5 illustrates a screen 500, which may be a web page, displayed to a user by the system 2, which allows a user to, for example: (1) enter a zip code into a ZIP code field 510; (2) indicate whether the zip code is intended to be (a) an origin zip code by selecting a “Shipped from this ZIP code” radio button 520, or (b) a destination zip code by selecting a “Shipped to this ZIP code” radio button 522; and (3) use a submit button 532 to submit the information to the system 2. In response, the system 2 then displays a time-in-transmit map for one or more particular carriers (the carrier is shown in FIG. 5 as UPS, although the carrier could be any other suitable carrier).

FIGS. 6 and 7 illustrate time-in-transmit maps that may be presented to a user upon a user's request, as in FIG. 5. As described more fully below, each map generally includes one or more time-in-transmit zones. In order for a user to be able to differentiate between each time-in-transmit zone, the time-in-transmit maps may be depicted in color, with each time-in-transmit zone represented by a different color. Alternatively, the time-in-transmit maps may be depicted in gray scale, with each time-in-transmit zone having a different gray scale value. As another alternative, the time-in-transmit maps may be depicted with hatch patterns, with each time-in-transmit zone having a different hatch pattern (see FIGS. 6 and 7). As may be appreciated by one in the relevant field, other methods of uniquely representing time-in-transmit zones on a map may be used.

In various embodiments, upon selecting a “Shipped to this ZIP code” button 522, the system 2 displays to a user an Inbound View time-in-transmit map 600, as shown in FIG. 6. In accordance with one embodiment of the present invention, and as shown in FIG. 6, the map may be of the United States and Puerto Rico. In alternative embodiments, the map may be of one or more other locations, such as states, regions, countries, continents, etc. As discussed above, the map may also include one or more geographical time-in-transmit zones that, in various embodiments, each include a plurality of locations that are grouped by a common time-in-transmit value. In other words, in particular embodiments, for every location within a particular time-in-transmit zone, the time-in-transmit to a specified location will be the same. The time-in-transmit zones may thus serve to visually convey the estimated time-in-transmit from locations within each particular time-in-transmit zone to locations within the zip code entered by the user in the ZIP Code field 510. The time-in-transmit zones of FIG. 6, for example, are grouped by number of days of transmit time, with each time-in-transmit zone representing a different number of days (although, in alternative embodiments, the zones may be assembled according to other suitable periods of time, such as hours).

As an example, the one-day time-in-transmit zone 610 shown in FIG. 6 serves to indicate that packages shipped to Lawrenceville, Ga. 30044 604 will take approximately one transmit day to be shipped to Lawrenceville from any location within the one-day time-in-transmit zone 610. Similarly, packages shipped from locations within the two-day time-in-transmit zone 620 will take approximately two transmit days to arrive in Lawrenceville 604. By the same token, packages will take: (1) approximately three transmit days to arrive in Lawrenceville 604 if shipped from locations within the three-day time-in-transmit zone 630; (2) approximately four days if shipped from locations within four-day time-in-transmit zone 640; (3) approximately five days if shipped from five-day time-in-transmit zone 650, and so forth for the six and seven day time-in-transmit zones 660, 670. A legend 602 may be used to assist a user in determining the estimated time-in-transmit for each time-in-transmit zone.

In particular embodiments, upon selecting “Shipped from this ZIP code” 520, the system 2 displays to a user an Outbound View time-in-transmit map 700 as shown in FIG. 7. As may be understood from FIG. 7, this Outbound View time-in-transmit map may be configured essentially the same as the Inbound View time-in-transmit map (e.g., it may include the same type of information, and show this information in the manner described above), with the time-in-transmit zones representing the time-in-transmit for a parcel traveling from an origin location (as shown by Lawrenceville, Ga. 704 in FIG. 7) to locations within each zone. However, due to the often asymmetric nature of inbound/outbound shipping, the size, shape, and/or location of the various time-in-transmit zones will typically be different than those shown in the corresponding Inbound View time-in-transmit map.

The system 2 may display time-in-transmit maps to a user, such as those shown in FIGS. 6 and 7, in any of several different ways. In one embodiment of the present invention (not shown), the system may generate, in advance, a unique time-in-transmit map for each unique and valid location identifier that may be input by a user (or for a subset of these location identifiers). For instance, if the system 2 is capable of generating maps of the United States, the system 2 may pre-develop maps for each known zip code in the United States, and thereafter store these maps within the system database 8, or other storage device. Upon a user entering a particular zip code to request a time-in-transmit map, such as in FIG. 5, the system 2 retrieves and displays to the user the pre-developed map for that particular zip code. Alternatively, in another embodiment of the present invention, the system 2 may be configured to generate and display a unique time-in-transmit map upon every request (or upon certain requests) by a user, without developing the map in advance of the request and storing it in a database.

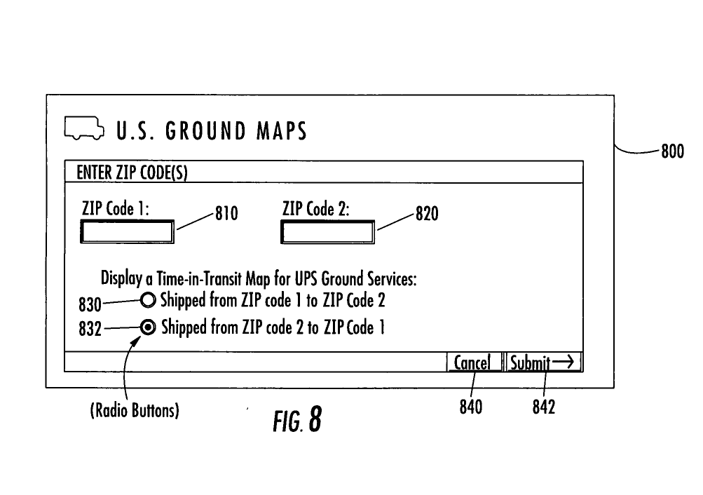

FIG. 8 represents an alternative embodiment of a web site 800 that a user may use to obtain time-in-transmit information from the system 2, according to one embodiment of the present invention. In this embodiment, the system may be adapted to allow a user to enter two location identifiers (shown in FIG. 8 as zip codes) and to generate and display time-in-transmit information between locations represented by the two zip codes. For example, a user may enter a first zip code in a “ZIP Code 1” field 810, and may enter a second zip code in a “ZIP Code 2” field 820. The user may then indicate, by clicking on the radio button which represents “Shipped from ZIP Code 1 to ZIP Code 2” 830, that he would like a time-in-transmit map to be displayed from the first zip code (indicated in the first field 810) to the second zip code (indicated in the second field 820). In this instance, ZIP Code 1 810 would be the origin zip code, and ZIP Code 2 820 would be the destination zip code.

Alternatively, the user may indicate that he would like a time-in-transmit map displayed from the second zip code to the first zip code, by clicking on the radio button which represents “Shipped from ZIP Code 2 to ZIP Code 1” 832. In this case, ZIP Code 2 820 would be the origin zip code, and ZIP Code 1 810 would be the destination zip code. This functionality may also allow a user to toggle back and forth between inbound and outbound time-in-transmit displays showing the estimated time-in-transmit for parcels sent between the two locations.

### ALTERNATIVE EMBODIMENTS

In one alternative embodiment (not shown), the system may be adapted to allow a user to enter two zip codes (see FIG. 8), and have the option of receiving a time-in-transmit map from ZIP Code 1 to ZIP Code 2, a time-in-transmit map from ZIP Code 2 to ZIP Code 1, or alternatively, to enter a selection to receive both time-in-transmit maps displayed at the same time.

In one embodiment, the system is configured to display, and allow a user to select, check boxes representing “Shipped from ZIP Code 1 to ZIP Code 2” and “Shipped from ZIP Code 2 to ZIP Code 1”. In various embodiments, the system would allow the user to potentially select both of these boxes.

Alternatively, the system may display radio buttons that, respectively, allow the user to select one of the following map displays: (1) a “Shipped from ZIP Code 1 to ZIP Code 2” time-in-transmit display; (2) a “Shipped from ZIP Code 2 to ZIP Code 1” time-in-transmit display; and (3) a “Shipped from ZIP Code 1 to ZIP Code 2” time-in-transmit display and a “Shipped from ZIP Code 2 to ZIP Code 1” time-in-transmit display (e.g., displayed simultaneously or in sequence).

Similarly, with reference to FIG. 5, the system 2 may display a third radio button (not shown) to the user which allows the user to select to receive two time-in-transmit maps (Shipped “to” and Shipped “from” the ZIP Code) at the same time, in the same display.

In an alternative embodiment, when a user selects a time-in-transmit map display option (such as the options indicated by radio buttons 830 or 832 in FIG. 8, or 520 and 522 in FIG. 5), the system 2 displays the requested time-in-transmit map to the user. In the case of the map being displayed via a web page, the screen (such as FIGS. 6 and 7) may include a hyperlink (not shown) which allows a user to see a reverse map of the time-in-transmit map being displayed. For example, in FIG. 5, if a user selects “Shipped from this ZIP Code” 520, the web page displaying the Outbound time-in-transmit map may have a hyperlink which states, for example, “View Time-in-Transit Map for UPS Ground Services Shipped to this ZIP Code”, and allows a user to view the corresponding Inbound time-in-transmit map. Alternatively, if the user selected “Shipped to this ZIP Code” 522, the web page displaying the Inbound time-in-transmit map may include a hyperlink which states, for example, “View Time-in-Transit Map for UPS Ground Services Shipped from this ZIP Code”, and allows a user to view the corresponding Outbound time-in-transmit map. Thus, the system 2 may be configured for allowing a user to toggle between time-in-transmit maps inbound and outbound from a particular zip code.

Similarly, with respect to FIG. 8, the system may allow a user to enter two zip codes in “ZIP Code 1” field 810 and “ZIP Code 2” field 820. If the user selects “Shipped from ZIP Code 1 to ZIP Code 2” 830, the system 2 may display the requested time-in-transmit map to the user via a web page (not shown). The web page displaying the time-in-transmit map may include a hyperlink which allows the user to “View Time-in-Transit Map for UPS Ground Services Shipped from ZIP Code 2 to ZIP Code 1”. Similarly, if the user selects “Shipped from ZIP Code 2 to ZIP Code 1” 832, the system 2 may display the requested time-in-transmit map to the user via a web page which also includes a hyperlink which allows the user to “View Time-in-Transit Map for UPS Ground Services Shipped from ZIP Code 1 to ZIP Code 2”. Thus, the system 2 may be configured for allowing a user to toggle between time-in-transmit maps for the two selected zip codes. In alternative embodiments: (1) inbound time-in-transmit information may be displayed from two or more particular ZIP codes to a particular destination location; and/or (2) outbound time-in-transmit information may be displayed to two or more particular ZIP codes from a particular origin location.

In another embodiment of the present invention, when a user requests time-in-transmit information from the system 2, the time-in-transmit information may be displayed to the user in a textual format, rather than as a graphical or map display. For instance, a user may be able to enter zip codes, as in FIG. 8, but may choose to receive textual time-in-transmit data between those two locations. Such a result may displayed (not shown) to a user, for example, as “Time in transmit from ZIP Code 1 to ZIP Code 2 is approximately 3 days; Time in Transit from ZIP Code 2 to ZIP Code 1 is approximately 2 days”.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer system that is adapted for:
receiving a location identifier from a user, said location identifier corresponding to a first location;
receiving, from said user, a “display outbound information” request that information be provided regarding the time that it would take to ship a parcel from said first location to a second location;
receiving, from said user, a “display inbound information” request that information be provided regarding the time that it would take to ship a parcel from said second location to said first location;
at least partially in response to receiving said “display outbound information” request, providing information to said user regarding the time that it would take to ship a parcel from said first location to said second location; and
at least partially in response to receiving said “display inbound information” request, providing information to said user regarding the time that it would take to ship a parcel from said second location to said first location.

2. The computer system of claim 1, wherein said location identifier is a zip code.

3. The computer system of claim 1, wherein said time that it would take to ship said parcel from said second location to said first location is different from said time that it would take to ship said parcel from said first location to said second location.

4. The computer system of claim 1, wherein said computer system is further adapted for:
at least partially in response to receiving said “display outbound information” request, providing information to said user regarding the time that it would take to ship a parcel from said first location to a third location; and
at least partially in response to receiving said “display inbound information” request, providing information to said user regarding the time that it would take to ship a parcel from said third location to said first location.

5. The computer system of claim 1, wherein:
said step of providing information to said user regarding the time that it would take to ship a parcel from said first location to said second location comprises the step of displaying, to said user, a graphical display indicating the time that it would take to ship a parcel from said first location to said second location; and
said step of providing information to said user regarding the time that it would take to ship a parcel from said second location to said first location comprises the step of displaying, to said user, a graphical display indicating the time that it would take to ship a parcel from said second location to said first location.

6. The computer system of claim 5, wherein:
said step of providing information to said user regarding the time that it would take to ship a parcel from said first location to said second location comprises the step of displaying, to said user, a graphical map display indicating the time that it would take to ship a parcel from said first location to said second location; and
said step of providing information to said user regarding the time that it would take to ship a parcel from said second location to said first location comprises the step of displaying, to said user, a graphical map display indicating the time that it would take to ship a parcel from said second location to said first location.

7. A computer system that is adapted for:
receiving a location identifier from a user, said location identifier corresponding to a particular location;
receiving, from said user, a “display inbound time-in-transmit map” request that an inbound time-in-transmit map be displayed, said inbound time-in-transmit map indicating the time that it would take to ship a parcel from each of a plurality of locations to said particular location;
receiving, from said user, a “display outbound time-in-transmit map” request that an outbound time-in-transmit map be displayed, said outbound time-in-transmit map indicating the time that it would take to ship a parcel from said particular location to each of said plurality of locations;
at least partially in response to receiving said “display inbound time-in-transmit map” request, displaying said inbound time-in-transmit map to said user; and
at least partially in response to receiving said “display outbound time-in-transmit map” request, displaying said outbound time-in-transmit map to said user.

8. The computer system of claim 7, wherein said location identifier is a zip code.

9. The computer system of claim 7, wherein said computer system is further adapted for allowing said user to toggle between: (A) a display of said inbound time-in-transmit map; and (B) a display of said outbound time-in-transmit map.

10. The computer system of claim 7, wherein said steps of receiving a “display inbound time-in-transmit map” request and receiving a “display outbound time-in-transmit map” request are executed substantially simultaneously.

11. The computer system of claim 10, wherein said steps of displaying said inbound time-in-transmit map to said user and displaying said outbound time-in-transmit map to said user are executed substantially simultaneously.

12. The computer system of claim 7, wherein said inbound time-in transmit map comprises:
A) a first zone comprising a first plurality of locations;
B) a second zone comprising a second plurality of locations;
C) a first graphical indication that it would take a first pre-determined period of time to ship a package from any location within said first zone to said particular location; and
D) a second graphical indication that it would take a second pre-determined period of time to ship a package from any location within said second zone to said particular location.

13. The computer system of claim 12, wherein:
said first graphical indication is a first particular color disposed within a graphical representation of said first zone; and
said second graphical indication is a second particular color disposed within a graphical representation of said second zone.

14. The computer system of claim 12, wherein:
said first graphical indication is a first particular pattern disposed within a graphical representation of said first zone; and
said second graphical indication is a second particular pattern disposed within a graphical representation of said second zone.

15. The computer system of claim 12, wherein said first pre-determined period of time is about one day.

16. The computer system of claim 12, wherein said second pre-determined period of time is about two days.

17. The computer system of claim 12, wherein said inbound time-in transmit map comprises:
E) a third zone comprising a third plurality of locations;
F) a fourth zone comprising a fourth plurality of locations;
G) a third graphical indication that it would take a third pre-determined period of time to ship a package from any location within said third zone to said particular location; and
H) a fourth graphical indication that it would take a fourth pre-determined period of time to ship a package from any location within said fourth zone to said particular location.

18. The computer system of claim 17, wherein:
said first period of time and said third period of time are the same; and
said second period of time and said fourth period of time are the same.

19. The computer system of claim 7, wherein said outbound time-in transmit map comprises:
A) a first zone comprising a first plurality of locations;
B) a second zone comprising a second plurality of locations;
C) a first graphical indication that it would take a first pre-determined period of time to ship a package from said particular location to any location within said first zone; and
D) a second graphical indication that it would take a second pre-determined period of time to ship a package from said particular location to any location within said second zone.

20. The computer system of claim 19, wherein:
said first graphical indication is a first particular color disposed within a graphical representation of said first zone; and
said second graphical indication is a second particular color disposed within a graphical representation of said second zone.

21. A computer system that is adapted for:
receiving a location identifier from a user, said location identifier corresponding to a particular location; and
allowing said user to issue a “display inbound time-in-transmit map” request that an inbound time-in-transmit map be displayed, said inbound time-in-transmit map indicating the time that it would take to ship a parcel from each of a plurality of locations to said particular location.

22. The computer system of claim 21, wherein said plurality of locations comprises at least three different locations.
